(19) United States
(12) Patent Application Publication
(10) Pub. No.: US 2023/0214848 A1
(43) Pub. Date: Jul. 6, 2023

(54) VERIFYING AND FLAGGING NEGATIVE FEEDBACK

(71) Applicant: International Business Machines Corporation, Armonk, NY (US)

(72) Inventors: Hemant Kumar Sivaswamy, Pune (IN); Venkata Vara Prasad Karri, Visakhapatnam (IN); Shikhar Kwatra, San Jose, CA (US); Afroz Khan, I, Davanagere (IN)

(21) Appl. No.: 17/647,035

(22) Filed: Jan. 5, 2022

(51) Int. Cl. G06Q 30/00; G06F 40/30

(52) U.S. Cl. CPC G06Q 30/018; G06F 40/30; G06Q 2220/00

(57) ABSTRACT

In an approach to verifying and flagging negative feedback, one or more computer processors monitor one or more websites for product feedback associated with a failed component of a product. One or more computer processors determine the product feedback is detected. One or more computer processors determine the product feedback is negative. One or more computer processors determine whether the failed component is present in a corresponding blockchain ledger. In response to determining the failed component is not present in a corresponding blockchain ledger, one or more computer processors refute the product feedback.

### BACKGROUND OF THE INVENTION

The present invention relates generally to the field of blockchain, and more particularly to verifying and flagging negative feedback.

A blockchain is a decentralized and distributed digital ledger that can record transactions between two or more parties efficiently and in a verifiable and permanent way. The ledger itself can also be programmed to trigger transactions automatically. A blockchain maintains a continuously growing list of records, called blocks, secured from tampering and revision. Each block contains a timestamp and a link to a previous block. By design, blockchains are inherently resistant to modification of the data—once recorded, the data in a block cannot be altered retroactively. Using a peer-to-peer network and a distributed timestamping server, a blockchain database is managed autonomously. The decentralized consensus algorithm of blockchain technologies allows several entities to maintain a shared record of information without having to trust each other individually, since consensus is formed on a per-network basis. The networked model produces a system with the advantages of censorship resistance, tamper resistance, and a system with no single point of failure.

The Internet of Things (IoT) is the internetworking of physical devices (also referred to as “connected devices” and “smart devices”), vehicles, buildings, and other items, embedded with electronics, software, sensors, actuators, and network connectivity that enable these objects to collect and exchange data. The IoT allows objects to be sensed and/or controlled remotely across existing network infrastructure, creating opportunities for more direct integration of the physical world into computer-based systems, and resulting in improved efficiency, accuracy, and economic benefit in addition to reduced human intervention. Each “thing” is uniquely identifiable through its embedded computing system but is able to interoperate within the existing Internet infrastructure.

Companies have been battling counterfeiters for years, investing significant time and resources to guard against the risk of defective and fake parts entering the production system and to prevent clever look-alikes and reverse-engineered goods from stealing sales. For much of that time, companies have been forced to operate partly in the dark, because fragmented data, networks, and sourcing arrangements make it difficult to trace and authenticate. The combination of blockchain and IoT can give manufacturers the ability to detect fraudulent activity. Advances in blockchain-with-IoT counterfeit detection provide at-a-glance visibility, tracing, and recording of provenance data from source to sale and beyond.

### SUMMARY

Embodiments of the present invention disclose a computer-implemented method, a computer program product, and a system for verifying and flagging negative feedback. The computer-implemented method may include one or more computer processors monitoring one or more websites for product feedback associated with a failed component of a product. One or more computer processors determine the product feedback is detected. One or more computer processors determine the product feedback is negative. One or more computer processors determine whether the failed component is present in a corresponding blockchain ledger. In response to determining the failed component is not present in a corresponding blockchain ledger, one or more computer processors refute the product feedback.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a feedback verification program, on a server computer within the distributed data processing environment of FIG. 1, for verifying and flagging negative feedback, in accordance with an embodiment of the present invention; and

FIG. 3 depicts a block diagram of components of the server computer executing the feedback verification program within the distributed data processing environment of FIG. 1, in accordance with an embodiment of the present invention.

### DETAILED DESCRIPTION

Many household items, e.g., a washing machine, a music system, a television, etc., are made up of several sub-components. Sometimes the failure of a critical sub-component can cause the whole item to fail. Repair of the item is often performed by the official customer service department of the manufacturer or seller, however at times, that may not be feasible. In general, repair should include substituting the failed sub-component with a quality replacement. Unfortunately, counterfeit components exist, and the repairing entity may knowingly or unknowingly install a poor-quality substitute. The problem of ensuring quality of a complex component made up of multiple sub-components sourced from multiple manufacturers is well-known. The scheme of tagging, or adding marks, to designate authenticity is also well-known. If a poor-quality substitute fails much earlier than would be expected of a good-quality substitute, the consumer can become frustrated and leave negative feedback on one or more social media outlets, such as a blog, a product website, and/or a customer service center, which can negatively impact the reputation of the manufacturer.

Embodiments of the present invention recognize that protecting the reputation of a manufacturer can be achieved by implementing a system that can determine whether negative feedback is addressed to a poor-quality component by tracking the component using the Internet of Things (IoT) and blockchain technologies. Embodiments of the present invention also recognize that protecting the reputation of a manufacturer can be achieved by implementing a system that dynamically identifies negative feedback made by a consumer and verifies the history of feedback made by the consumer. Embodiments of the present invention also recognize that protecting the reputation of a manufacturer can be achieved by implementing a system that tracks negative reviews and flags invalid reviews to avoid negative branding. Implementation of embodiments of the invention may take a variety of forms, and exemplary implementation details are discussed subsequently with reference to the Figures.

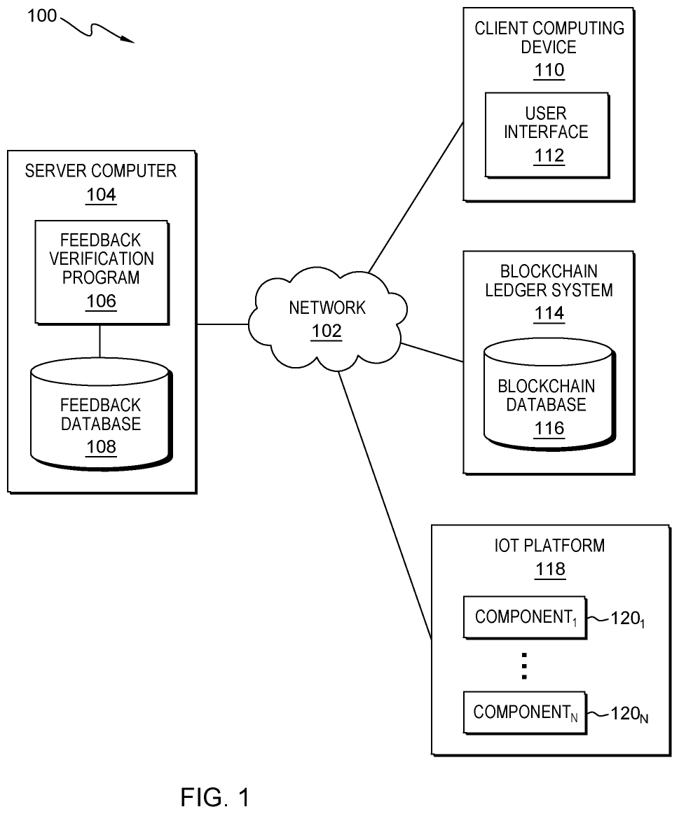

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104, client computing device 110, blockchain ledger system 114, and Internet of Things (IoT) platform 118, all interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 110, blockchain ledger system 114, IoT platform 118, and other computing devices (not shown) within distributed data processing environment 100.

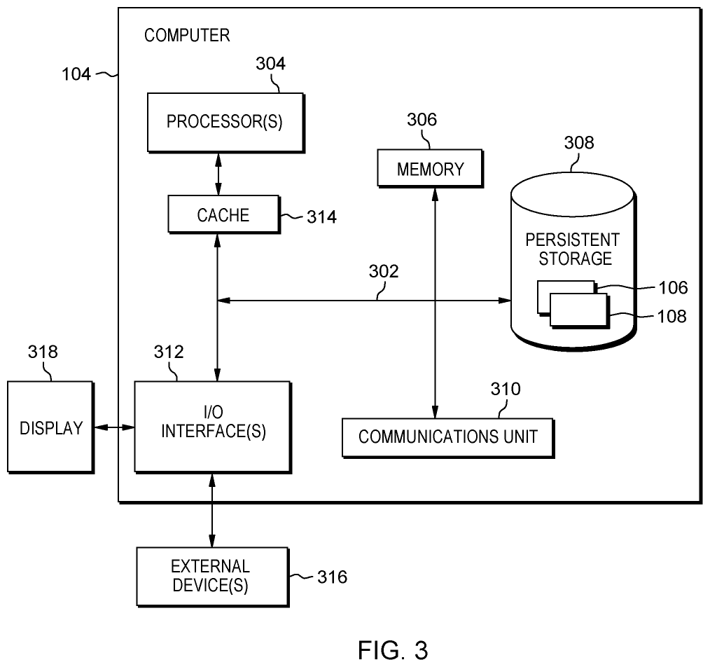

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, an edge device, a containerized workload, or any programmable electronic device capable of communicating with client computing device 110, blockchain ledger system 114, IoT platform 118, and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes feedback verification program 106 and feedback database 108. Server computer 104 may include internal and external hardware components, as depicted and described in further detail with respect to FIG. 3.

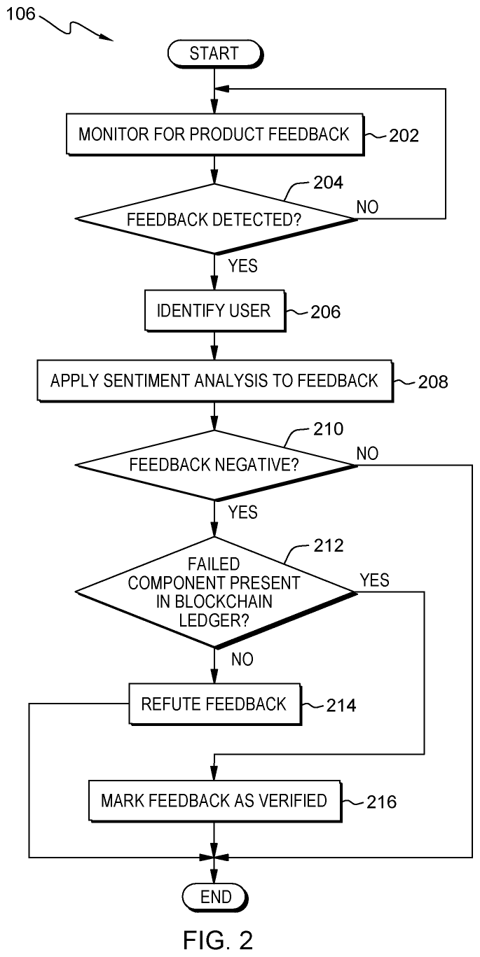

Feedback verification program 106 identifies whether a failed sub-component has been replaced with an unauthorized component tracked using IoT and blockchain technologies and determines whether associated negative feedback is justified. In an embodiment, feedback verification program 106 includes one or more machine learning models. Feedback verification program 106 monitors for product feedback. Feedback verification program 106 determines whether feedback is detected. If feedback is detected, then feedback verification program 106 identifies the user that submitted the feedback. Feedback verification program 106 applies sentiment analysis to the feedback and determines whether the feedback is negative. If the feedback is negative, then feedback verification program 106 determines whether the failed component is present in a blockchain ledger. If feedback verification program 106 determines the failed component is not present in the blockchain ledger, then feedback verification program 106 refutes the feedback. If the failed component is present in the blockchain ledger, then feedback verification program 106 marks the feedback as verified. Feedback verification program 106 is depicted and described in further detail with respect to FIG. 2.

Feedback database 108 stores information used by and generated by feedback verification program 106, client computing device 110, and IoT platform 118. In the depicted embodiment, feedback database 108 resides on server computer 104. In another embodiment, feedback database 108 may reside elsewhere within distributed data processing environment 100, provided that feedback verification program 106, client computing device 110, and IoT platform 118 have access to feedback database 108, via network 102. A database is an organized collection of data. Feedback database 108 can be implemented with any type of storage device capable of storing data and configuration files that can be accessed and utilized by feedback verification program 106, client computing device 110, and IoT platform 118, such as a database server, a hard disk drive, or a flash memory. Feedback database 108 stores consumer feedback for one or more products and/or one or more sub-components of the one or more products. Feedback database 108 also stores product registration information input by either the consumer, i.e., the user of client computing device 110, via user interface 112, or by the seller of the product, on behalf of the consumer. In an embodiment, as part of the product registration, feedback database 108 also stores a user profile for the consumer, i.e., the user of client computing device 110. The user profile may include, but is not limited to, the name of the user, an address, an email address, an image of the user, a voice sample, a phone number, a credit card number, an account number, a business loyalty account number, a student identification number, an employer, a job role, a job family, a business unit association, a job seniority, a job level, a resume, a social network affiliation, a current geographic location, etc. In an embodiment, the user profile is associated with a manufacturer and/or a seller of a product purchased by the user of client computing device 110. In an embodiment, responsive to registration of the product to the user, the user profile also stores tags and/or identification of each of the components in the product.

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails and texts begin with a written notification that the user's information may be recorded or monitored and may be saved, for the purpose of verifying feedback. These embodiments may also include periodic reminders of such recording and monitoring throughout the course of any such use. Certain embodiments may also include regular (e.g., daily, weekly, monthly) reminders to the participating parties that they have consented to being recorded and monitored for verifying feedback and may provide the participating parties with the opportunity to opt-out of such recording and monitoring if desired. Furthermore, to the extent that any non-participating parties' actions are monitored (for example, when outside vehicles are viewed), such monitoring takes place for the limited purpose of providing navigation assistance to a participating party, with protections in place to prevent the unauthorized use or disclosure of any data for which an individual might have a certain expectation of privacy.

The present invention may contain various accessible data sources, such as feedback database 108, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Feedback verification program 106 enables the authorized and secure processing of personal data. Feedback verification program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Feedback verification program 106 provides information regarding personal data and the nature (e.g., type, scope, purpose, duration, etc.) of the processing. Feedback verification program 106 provides the user with copies of stored personal data. Feedback verification program 106 allows the correction or completion of incorrect or incomplete personal data. Feedback verification program 106 allows the immediate deletion of personal data.

Client computing device 110 can be one or more of a laptop computer, a tablet computer, a smart phone, smart watch, a smart speaker, or any programmable electronic device capable of communicating with various components and devices within distributed data processing environment 100, via network 102. Client computing device 110 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In an embodiment, the wearable computer may be in the form of a smart watch. In an embodiment, client computing device 110 may be integrated into a vehicle of the user. For example, client computing device 110 may include a heads-up display in the windshield of the vehicle. In general, client computing device 110 represents one or more programmable electronic devices or combination of programmable electronic devices capable of executing machine readable program instructions and communicating with other computing devices (not shown) within distributed data processing environment 100 via a network, such as network 102. Client computing device 110 includes an instance of user interface 112.

User interface 112 provides an interface for a user of client computing device 110 to interact with one or more of a plurality of online applications and/or websites (not shown) to register a purchased product with the seller and/or the manufacturer of the product. User interface 112 also enables a user of client computing device 110 to leave feedback regarding a repaired item on the plurality of online applications and/or websites. In one embodiment, user interface 112 is mobile application software. In addition, user interface 112 enables a user to store a user profile in feedback database 108. Mobile application software, or an “app,” is a computer program designed to run on smart phones, tablet computers and other mobile devices. In one embodiment, user interface 112 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program.

Blockchain ledger system 114 is one or more of a plurality of systems known in the art which can be used to store records of digital value, for example, transactions, identities, assets, documents, and properties, into an immutable ledger, or to add self-enforcing business logic to the ledger, such as smart contracts. In one embodiment, blockchain ledger system 114 is permissionless, i.e., a public blockchain system open for participation to anyone. In another embodiment, blockchain ledger system 114 is permissioned, i.e., a private blockchain system available only to a closed group of participants. In the depicted embodiment, blockchain ledger system 114 resides outside of server computer 104. In another embodiment, blockchain ledger system 114 may reside on server computer 104 or elsewhere within distributed data processing environment 100, provided feedback verification program 106 has access to blockchain ledger system 114. Blockchain ledger system 114 includes blockchain database 116.

Blockchain database 116 is a repository, i.e., a ledger, for data used by feedback verification program 106 corresponding to blockchain ledger system 114. Blockchain database 116 can represent one or more databases. In the depicted embodiment, blockchain database 116 resides on blockchain ledger system 114. In another embodiment, blockchain database 116 may reside elsewhere within distributed data processing environment 100, provided feedback verification program 106 and blockchain ledger system 114 have access to blockchain database 116. Blockchain database 116 can be implemented with any type of storage device capable of storing data and configuration files that can be accessed and utilized by feedback verification program 106, such as a database server, a hard disk drive, or a flash memory. Blockchain database 116 stores data associated with the identification of one or more products and/or one or more sub-components of the one or more products, i.e., component 120_{1-N}. For example, product identification may include, but is not limited to, a manufacturer name, a unique manufacturer identification number, a model number, a serial number, a date of manufacture, a time of manufacture, a lot number, an identification of an assembler of the component, a description of the component, e.g., a size, a color, a weight, etc. Registration of components such as component 120_{1-N} in blockchain database 116 enables complete transparency that can be tracked within a blockchain network node, i.e., blockchain ledger system 114, for the status and/or health of the component at any given time in the lifetime of the component. In an embodiment, blockchain database 116 also stores a continuous stream of component metadata from one or more sensors associated with component 120_{1-N}.

IoT platform 118 is a suite of components that enable a) deployment of applications that monitor, manage, and control connected devices and sensors; b) remote data collection from connected devices; and c) independent and secure connectivity between devices. The suite of components may include, but are not limited to, a hardware architecture, an operating system, a runtime library, an edge device, and/or a containerized workload (not shown). In the depicted embodiment, IoT platform 118 includes component 120_{1-N}. In another embodiment, IoT platform 118 may include a plurality of other computing devices and/or sensors.

Component 120_{1-N}, herein component(s) 120, are a plurality of components included in a purchased product that are associated with IoT platform 118. As used herein, N represents a positive integer, and accordingly the number of scenarios implemented in a given embodiment of the present invention is not limited to those depicted in FIG. 1. Component(s) 120 are each tagged with a unique identification number to enable tracking by blockchain ledger system 114. The unique identification numbers are stored in blockchain database 116. In an embodiment, each of component(s) 120 includes one or more sensors to detect data associated with the component. In an embodiment, feedback verification program 106 continuously receives streams of information from sensors associated with component(s) 120 and adds the received data as metadata in the corresponding node of blockchain database 116. For example, component 120₁ may include a temperature sensor such that feedback verification program 106 continuously logs operating temperatures of component 120₁ in blockchain database 116.

FIG. 2 is a flowchart depicting operational steps of feedback verification program 106, on server computer 104 within distributed data processing environment 100 of FIG. 1, for verifying and flagging negative feedback, in accordance with an embodiment of the present invention.

Feedback verification program 106 monitors for product feedback (step 202). In an embodiment, feedback verification program 106 monitors one or more websites, social networks, etc., for feedback associated with a product. In an embodiment, feedback verification program 106 uses a web crawler to monitor for product feedback. A web crawler is one or more of a plurality of internet bots that systematically browses the web, typically for the purpose of web indexing, as would be recognized by a person of skill in the art. In an embodiment, feedback verification program 106 searches for feedback on a specific product. In another embodiment, feedback verification program 106 searches for feedback associated with a plurality of products manufactured by the same manufacturer.

Feedback verification program 106 determines whether feedback is detected (decision block 204). In an embodiment, feedback verification program 106 analyzes the search results of the monitoring to detect feedback associated with a product. If feedback verification program 106 determines feedback is not detected (“no” branch, decision block 204), then feedback verification program 106 returns to step 202 and continues to monitor for product feedback.

If feedback verification program 106 determines feedback is detected (“yes” branch, decision block 204), then feedback verification program 106 identifies the user that submitted the feedback (step 206). In an embodiment, feedback verification program 106 accesses the user profile associated with the user that submitted the feedback, stored in feedback database 108, to identify the user and confirm that the user that posted the feedback is the product owner. In an embodiment, feedback verification program 106 verifies the identity of the user that posted the feedback against the profile of the user and the product using feature mapping. For example, feedback verification program 106 may use one or more natural language processing (NLP) techniques for understanding topics and categorizing topics into entities, such as Latent Dirichlet Allocation (LDA) and entity resolution matching, as would be recognized by a person of skill in the art.

Feedback verification program 106 applies sentiment analysis to the feedback (step 208). As would be recognized by a person of skill in the art, sentiment analysis refers to the use of NLP, text analysis, computational linguistics, and biometrics to systematically identify, extract, quantify, and study affective states and subjective information. Sentiment analysis is widely applied to voice of the customer materials such as reviews and survey responses, online and in social media, and healthcare materials for applications that range from marketing to customer service to clinical medicine. In an embodiment, feedback verification program 106 applies sentiment analysis to the detected feedback to determine customer satisfaction with the product associated with the feedback.

Feedback verification program 106 determines whether the feedback is negative (decision block 210). In an embodiment, based on the sentiment analysis, feedback verification program 106 determines whether the feedback submitted by the user of client computing device 110 is positive or negative toward the product. For example, feedback verification program 106 identifies whether the feedback mentions a failed component, for example, one or more of component(s) 120. If feedback verification program 106 determines the feedback is not negative (“no” branch, decision block 210) then feedback verification program 106 ends.

In an embodiment, in addition to determining whether the feedback is negative, feedback verification program 106 determines one or more characteristics associated with the user to establish the user's bias toward the product and/or the manufacturer and the ability the user has to express opinions about the quality of a particular product based on the genuine provenance of the components being used, i.e., feedback verification program 106 determines if the user is in good standing with respect to providing feedback on the product. For example, feedback verification program 106 may review the profile of the user stored in feedback database 108 to determine a level of technical knowledge of the user. In another example, feedback verification program 106 may search for other feedback submitted by the same user to determine whether a pattern exists in the user's feedback. In yet another example, feedback verification program 106 may compare the user's feedback for the failed component to the feedback of one or more other users of the same component to determine whether other users had the same experience. In an embodiment, feedback verification program 106 may apply a weight to the feedback based on one or more factors, including, but not limited to, an established bias, a user profile, a user feedback history, etc.

If the feedback verification program 106 determines the feedback is negative (“yes” branch, decision block 210), then feedback verification program 106 determines whether the failed component is present in the blockchain ledger (decision block 212). In an embodiment, feedback verification program 106 determines whether a failed component mentioned in the negative feedback, e.g., one or more of component(s) 120, is registered in blockchain database 116. For example, feedback verification program 106 determines whether the failed component is listed in a bill of materials for a product purchased by the user of client computing device 110. In an embodiment, feedback verification program 106 determines whether blockchain database 116 has received metadata in the past and/or is currently receiving metadata from the failed component.

In an embodiment, feedback verification program 106 traverses the node along the blockchain framework at different time instances when feedback verification program 106 identifies a trigger, such as the negative feedback. In a time-sensitive blockchain network, different nodes are appended as soon as a trigger occurs or a threshold is crossed. Blockchain ledger system 114 stores information about a specific component of component(s) 120 and associated metadata in a corresponding node in blockchain database 116. As time passes, feedback verification program 106 can trace the lineage of the triggers and/or events in blockchain database 116, e.g., replacement of a faulty component. In an embodiment, feedback verification program 106 uses a raft consensus algorithm, as would be recognized by a person of skill in the art, to incorporate respective parties of interest, i.e., blockchain participants, involved in the node appending and addition process. In an embodiment, feedback verification program 106, using one or more machine learning techniques, detects a usage pattern associated with one or more of component(s) 120, i.e., how the data produced by the component changes based on the usage of the component and/or how the component behaves under different conditions. For example, when a component in the product is replaced, feedback verification program 106 determines whether that component, or any other component, starts to produce uncharacteristic data, e.g., random noise. Continuing the example, feedback verification program 106 determines that prior to component replacement, data from a temperature sensor associated with component 120₁ was in the range of 33-80 degrees Fahrenheit, but after replacing component 120₁, the temperature sensor data is in the range of 95-105 degrees Fahrenheit, which feedback verification program 106 considers faulty readings.

If feedback verification program 106 determines the failed component is not present in the blockchain ledger (“no” branch, decision block 212), then feedback verification program 106 refutes the feedback (step 214). In an embodiment, if the failed component associated with the product for which the user of client computing device 110 submitted negative feedback is not included in blockchain database 116, then feedback verification program 106 determines the failed component is not legitimate, i.e., the component is likely a counterfeit component, and feedback verification program 106 flags the negative feedback as “not valid.” In an embodiment, feedback verification program 106 includes a reason, such as any collected evidence, in a flag. For example, if the user posted the feedback at the website of the manufacturer, then feedback verification program 106 posts a follow up message to the negative feedback on the website stating that the failed component was likely a fake or counterfeit component. In another example, if the user posted the feedback in a social media network or unofficial blog, then feedback verification program 106 posts a follow up message in the social media network that includes a link to the manufacturer's web site to inform followers and/or “friends” of the user that the failed component was not authorized by the manufacturer. In an embodiment where feedback verification program 106 determines the user that posted the negative feedback is not in good standing with respect to posting negative feedback, feedback verification program 106 may reference the user's standing when refuting the feedback. For example, feedback verification program 106 may include a comment that describes the user as unaware of the origin of the failed component. In another example, feedback verification program 106 may message the user directly and ask the user to refrain from posting additional negative feedback.

In an embodiment, as part of pre-training of feedback verification program 106, feedback verification program 106 simulates an “as-is” scenario to demonstrate what would have happened if the initial replacement of the component had used a genuine, authorized component that is present in blockchain ledger system 114. The simulation can describe the advantages of using an authorized component as well as including positive feedback from social and crowd sourced data points. The simulation helps in pretraining machine learning models associated with feedback verification program 106 and performing a quick analysis in order to provide the same outcome (i.e., refuting or modifying feedback), since the ensemble models are now pre-trained on those components instead of being trained for the first time on some components which were not registered with blockchain ledger system 114. In an embodiment, feedback verification program 106 defines one or more issues that may arise in the future using an ensemble framework of machine learning algorithms working together, for example, NLP techniques, gathering IoT information, and performing analyses on the data.

If feedback verification program 106 determines the failed component is present in the blockchain ledger (“yes” branch, decision block 212), then feedback verification program 106 marks the feedback as verified (step 216). In an embodiment, if the failed component associated with the product for which the user of client computing device 110 submitted negative feedback is included in blockchain database 116, then feedback verification program 106 determines the component is an authorized component, and feedback verification program 106 verifies that the negative feedback justified.

In an embodiment, feedback verification program 106 transmits the outcome of the process to the manufacturer such that the manufacturer can use the information to refine a list of authorized component vendors. In an embodiment, feedback verification program 106 transmits the outcome of the process to the manufacturer and/or seller of the product such that the manufacturer and/or seller can use the information to modify warranty and/or insurance policies and/or periods.

In an embodiment, feedback verification program 106 continually ingests available data from component(s) 120 and, instead of reacting when negative feedback is detected, feedback verification program 106 proactively compiles a list of actions to perform in response to events such as receiving a complaint, various review comments, and/or one or more other factors related to metadata information gathered from blockchain database 116, such as a faulty connection, faulty information correlated with one or more comments, invalid values, etc. In an embodiment, feedback verification program 106 continues to gather information from component(s) 120 until a pre-defined confidence level is reached before pushing the data to the node in blockchain database 116.

In an example of the use of feedback verification program 106, a user purchases a music system from an authorized shop or a franchisee shop. After a period of time passes, the music system breaks down, and the user takes it to a local service center to have the system repaired. The service center determines which component failed and replaces the failed component with a duplicate part that is not authorized by the manufacturer. The user uses the music system for a short time until the duplicate component fails. The user is dissatisfied and submits negative feedback to the website of the music system manufacturer. Feedback verification program 106 detects the feedback and identifies the user, as discussed with respect to decision block 204 and step 206. Feedback verification program 106 applies sentiment analysis to the feedback and determines the feedback is negative, as discussed with respect to step 208 and decision block 210. Feedback verification program 106 determines the failed component is not present in blockchain database 116 and posts a message on the manufacturer's web site to refute the negative feedback, as discussed with respect to decision block 212 and step 214.

FIG. 3 depicts a block diagram of components of server computer 104 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Server computer 104 can include processor(s) 304, cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306.

Program instructions and data used to practice embodiments of the present invention, e.g., feedback verification program 106 and feedback database 108, are stored in persistent storage 308 for execution and/or access by one or more of the respective processor(s) 304 of server computer 104 via cache 314. In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of client computing device 110, blockchain ledger system 114, and IoT platform 118. In these examples, communications unit 310 includes one or more network interface cards. Communications unit 310 may provide communications through the use of either or both physical and wireless communications links. Feedback verification program 106, feedback database 108, and other programs and data used for implementation of the present invention, may be downloaded to persistent storage 308 of server computer 104 through communications unit 310.

I/O interface(s) 312 allows for input and output of data with other devices that may be connected to server computer 104. For example, I/O interface(s) 312 may provide a connection to external device(s) 316 such as a keyboard, a keypad, a touch screen, a microphone, a digital camera, and/or some other suitable input device. External device(s) 316 can also include portable computer readable storage media such as, for example, thumb drives, portable optical or magnetic disks, and memory cards. Software and data used to practice embodiments of the present invention, e.g., feedback verification program 106 and feedback database 108 on server computer 104, can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touch screen, such as a display of a tablet computer.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing descriptions of the various embodiments of the present invention have been presented for purposes of illustration and example, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
monitoring, by one or more computer processors, one or more websites for product feedback associated with a failed component of a product;
determining, by one or more computer processors, the product feedback is detected;
determining, by one or more computer processors, the product feedback is negative;
determining, by one or more computer processors, whether the failed component is present in a corresponding blockchain ledger; and
responsive to determining the failed component is not present in the corresponding blockchain ledger, refuting, by one or more computer processors, the product feedback.

2. The computer-implemented method of claim 1, further comprising:
responsive to determining the failed component is present in the corresponding blockchain ledger, marking, by one or more computer processors, the product feedback as verified.

3. The computer-implemented method of claim 1, wherein determining the product feedback is negative further comprises:
applying, by one or more computer processors, a sentiment analysis to the product feedback.

4. The computer-implemented method of claim 1, further comprising:
identifying, by one or more computer processors, a user associated with the negative product feedback.

5. The computer-implemented method of claim 4, wherein identifying the user associated with the negative product feedback further comprises:
accessing, by one or more computer processors, a profile associated with the user; and
confirming, by one or more computer processors, that the user is an owner of the product.

6. The computer-implemented method of claim 1, further comprising:
simulating, by one or more computer processors, an “as-is” scenario to demonstrate a result of replacing a first component with a second component that is present in the corresponding blockchain ledger.

7. The computer-implemented method of claim 1, further comprising:
determining, by one or more computer processors, metadata associated with the failed component is not present in the corresponding blockchain ledger.

8. A computer program product comprising:
one or more computer readable storage media and program instructions collectively stored on the one or more computer readable storage media, the stored program instructions comprising:
program instructions to monitor one or more websites for product feedback associated with a failed component of a product;
program instructions to determine the product feedback is detected;
program instructions to determine the product feedback is negative;
program instructions to determine whether the failed component is present in a corresponding blockchain ledger; and
responsive to determining the failed component is not present in the corresponding blockchain ledger, program instructions to refute the product feedback.

9. The computer program product of claim 8, the stored program instructions further comprising:
responsive to determining the failed component is present in the corresponding blockchain ledger, program instructions to mark the product feedback as verified.

10. The computer program product of claim 8, wherein the program instructions to determine the product feedback is negative comprise:
program instructions to apply a sentiment analysis to the product feedback.

11. The computer program product of claim 8, the stored program instructions further comprising:
program instructions to identify a user associated with the negative product feedback.

12. The computer program product of claim 11, wherein the program instructions to identify the user associated with the negative product feedback comprise:
program instructions to access a profile associated with the user; and
program instructions to confirm that the user is an owner of the product.

13. The computer program product of claim 8, the stored program instructions further comprising:
program instructions to simulate an “as-is” scenario to demonstrate a result of replacing a first component with a second component that is present in the corresponding blockchain ledger.

14. The computer program product of claim 8, the stored program instructions further comprising:
program instructions to determine metadata associated with the failed component is not present in the corresponding blockchain ledger.

15. A computer system comprising:
one or more computer processors;
one or more computer readable storage media;
program instructions collectively stored on the one or more computer readable storage media for execution by at least one of the one or more computer processors, the stored program instructions comprising:
program instructions to monitor one or more websites for product feedback associated with a failed component of a product;
program instructions to determine the product feedback is detected;
program instructions to determine the product feedback is negative;
program instructions to determine whether the failed component is present in a corresponding blockchain ledger; and
responsive to determining the failed component is not present in the corresponding blockchain ledger, program instructions to refute the product feedback.

16. The computer system of claim 15, the stored program instructions further comprising:
responsive to determining the failed component is present in the corresponding blockchain ledger, program instructions to mark the product feedback as verified.

17. The computer system of claim 15, wherein the program instructions to determine the product feedback is negative comprise:
program instructions to apply a sentiment analysis to the product feedback.

18. The computer system of claim 15, the stored program instructions further comprising:
program instructions to identify a user associated with the negative product feedback.

19. The computer system of claim 18, wherein the program instructions to identify the user associated with the negative product feedback comprise:
program instructions to access a profile associated with the user; and
program instructions to confirm that the user is an owner of the product.

20. The computer system of claim 15, the stored program instructions further comprising:
program instructions to determine metadata associated with the failed component is not present in the corresponding blockchain ledger.
